(19) United States
(12) Patent Application Publication
(10) Pub. No.: US 2014/0292485 A1
(43) Pub. Date: Oct. 2, 2014

(54) ISSUE IDENTIFICATION

(71) Applicant: Hewlett-Packard Development Company, L.P., Houston, TX (US)

(72) Inventors: Fabio Giannetti, Sannyvale, CA (US); Adriane Cardozo, Porto Alegre (BR)

(21) Appl. No.: 13/851,045

(22) Filed: Mar. 26, 2013

(51) Int. Cl. G08B 5/22

(52) U.S. Cl. CPC G08B 5/22
USPC 340/7.58

(57) ABSTRACT

An example method includes receiving an alert initiated by an operator through a detector associated with a station in a production workflow; presenting, responsive to the alert, a user interface to the operator; receiving from the operator, via the user interface, information related to an issue; and identifying a production workflow factor based at least in part on the information related to the issue received from the operator.

### BACKGROUND

In various production environments, human operators may be assigned to one or more stations to operate and/or monitor equipment. For example, in production of printed products, print service providers (PSPs) may include stations for different operations in the print process. Multiple identical stations may be provided for each operation. In some examples, the production of a product may progress through various different stations.

### BRIEF DESCRIPTION OF THE DRAWINGS

For a more complete understanding of various examples, reference is now made to the following descriptions taken in connection with the accompanying drawings in which:

FIG. 1 illustrates an example system;

FIG. 2 illustrates an example process at a station;

FIGS. 3A-3C illustrate screenshots of an example process for various scenarios at a station;

FIG. 4 illustrates an example code for operation of a station using Job Definition Format (JDF);

FIG. 5 is a flowchart illustrating an example process; and

FIG. 6 is a flowchart illustrating another example process.

### DETAILED DESCRIPTION

In various examples, production workflow issues may be identified as part of the workflow process. Operators at various stations in the workflow process may initiate an interaction between the operator and a central controller to provide information to the central controller indicative of an issue. In various examples, the operator may scan the operator's badge at the station, using a detector associated with the station, to initiate an alert. In various examples, the badge may include a radio frequency identifier (RFID) tag, and the detector may be an RFID reader. In other examples, the badge may include a printed identifier, such as a bar code, and the detector may be an optical scanner for reading the printed identifier. In various examples, the detector may be part of the production workflow and may be used, for example, for detecting and/or identifying particular jobs in the production workflow. Thus, the detection of an operator's badge, in place of or in addition to an identifier of the job, may serve as an indication of an alert. In this regard, various examples described herein may provide for the capture of information related to various issues in the production workflow as an integrated part of the workflow.

Upon receiving the alert, the central controller may cause a user interface to be presented to the operator. The operator may then indicate information related to the issue, for example, including the type of issue (e.g., an operator issue, a resource issue or a device issue) and/or an indication of the specific issue (e.g., equipment maintenance required or paper needed for a printer). The central controller may use this information, which may be received from numerous stations and accumulated over time, to identify production workflow factors which may require attention. For example, the central controller may identify factors such as insufficient manpower, defective equipment which requires frequent maintenance or insufficient paper supply.

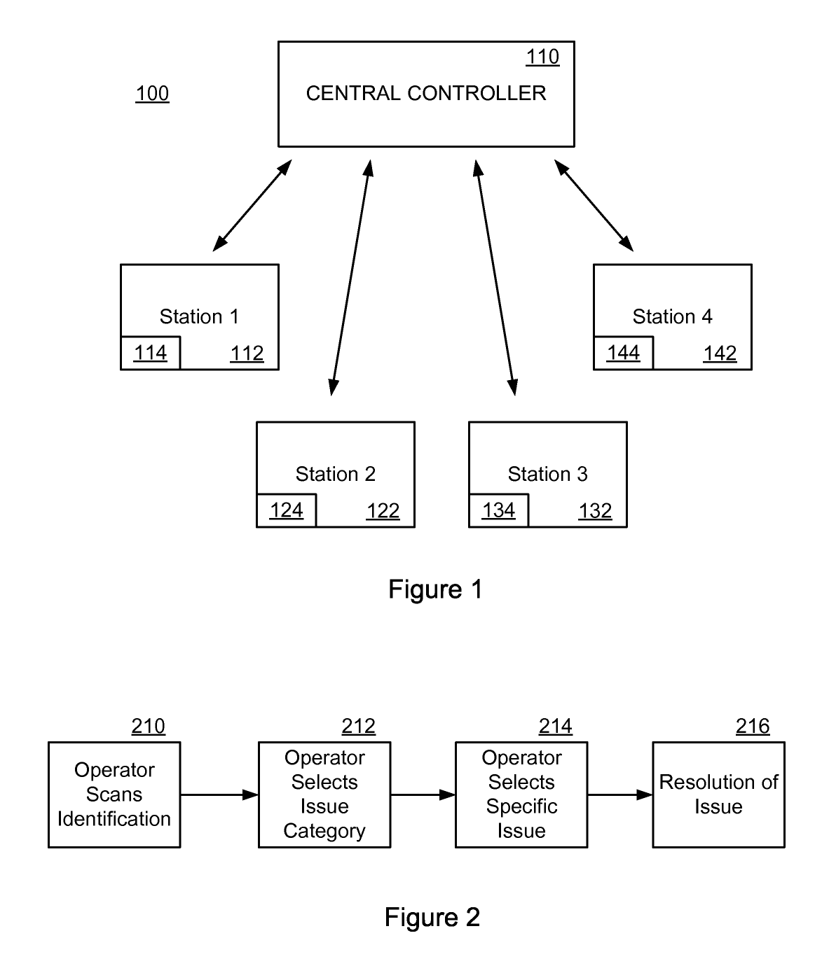

Referring now to FIG. 1, an example system is illustrated. The example system 100 may include a central controller 110 in communication with one or more stations 112, 122, 132, 142. The stations 112, 122, 132, 142 may correspond to various functions or processes, for example, which may be performed in a production workflow. In one example, the production workflow may be for a print service provider which may provide printed products with printed content. In this example, the various processes performed in the production workflow may include, but not limited to, pre-pressing, printing content and application of a finish. In the example of FIG. 1, the station 112 may be a station for performing pre-pressing for a print product, the stations 122 and 132 may be stations for performing printing of content, and the station 142 may be a station for finishing of the print product (e.g., application of a varnish).

The communication between the stations 112, 122, 132, 142 and the central controller 110 may be achieved in any of a variety of manners. For example, in cases where all stations 112, 122, 132, 142 and the central controller 110 are in close proximity to each other, the communication may be achieved through Ethernet cables or any other hard-wired connection. In other examples, the communication may be achieved through a network that may be wired or wireless. In various examples, the network may be a local area network or a wide area network (e.g., Internet).

In various examples, one or more of the stations 112, 122, 132, 142 may be provided with a detector, such as the detectors 114, 124, 134, 144. The detectors 114, 124, 134, 144 may be integrally formed as part of the stations 112, 122, 132, 142 or may be peripheral to the stations 112, 122, 132, 142. In various examples, the detectors may be barcode scanners, radio frequency identifier (RFID) readers or any other detector for detecting, reading or identifying an identifier. The detectors 114, 124, 134, 144 and/or the stations 112, 122, 132, 142 may include or be coupled to a workstation or a monitor which allows an operator to provide input to the station and/or to the central controller.

Referring now to FIG. 2, an example process is illustrated which may occur at, for example, one of the stations 112, 122, 132, 142 described above in the example of FIG. 1. In accordance with the example of FIG. 2, an operator may initiate an alert by presenting an identifier to a detector (e.g., the detectors 114, 124, 134, 144 of FIG. 1) (block 210). The identifier may be a badge belonging to the operator (e.g., ID badge) which may have an embedded code (e.g., electronic code) or an RFID. In some examples, the identifier may be a printed identifier, such as a bar code. In various examples, the detector 114, 124, 134, 144 may be a corresponding reader of the identifier (e.g., an RFID reader or a bar code scanner). The operator may initiate the alert upon any of a variety of conditions that may be, for example, contrary to normal operation of the station.

The operator may then select a category corresponding to an issue which may be affecting the operation of the station and/or the production workflow (block 212). In various examples, the categories may be indicative of the source of the issue. For example, the categories of issues may include resource issues, device issues or operator issues. The operator may further specify the nature of the issue by providing further information in addition to the category (block 214). For example, for a resource issue, the operator may specify the issue as insufficient paper or insufficient ink at a station. An indication of the resolution of the issue, such as the addition of paper or ink, may be provided (block 216). In various examples, the indication of resolution may be provided either manually by the operator or by the station through, for examples, sensors which detect the resolution.

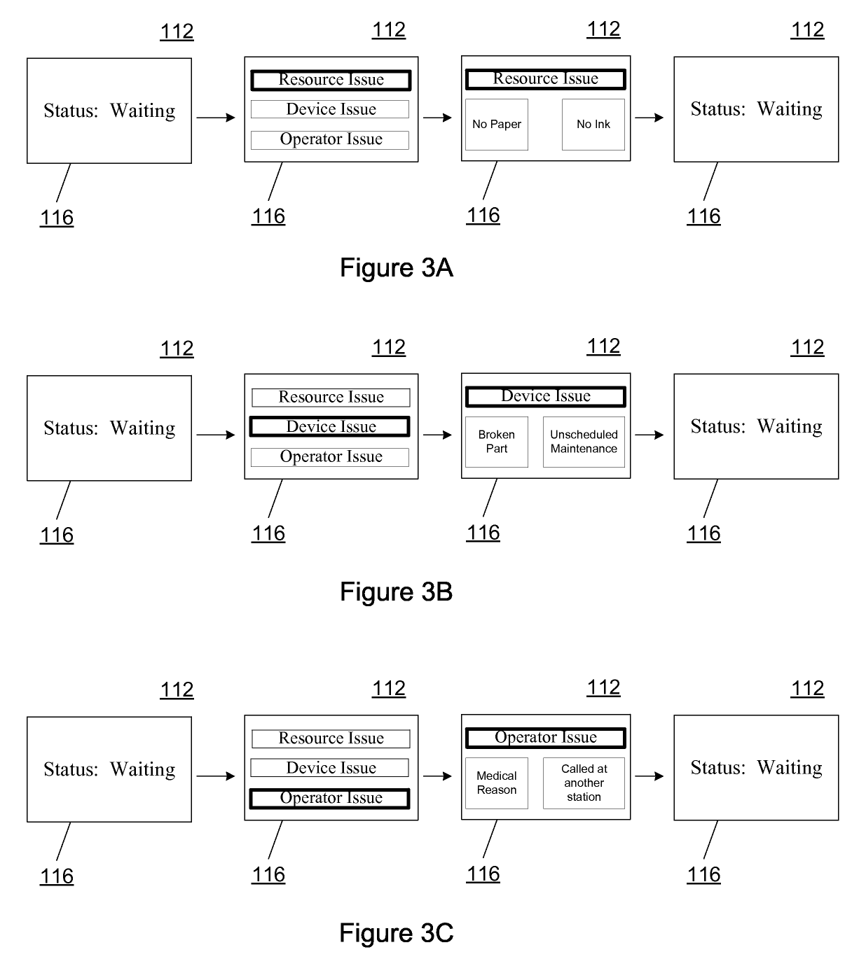

FIGS. 3A-3C illustrate screenshots of an example process for various scenarios at a station. In this regard, a station may be provided with a monitor and/or workstation through which an operator may interact with the station and/or the central controller. In each of FIGS. 3A-3C, the example screenshots are illustrated on a monitor 116 at the station 112. In the illustrated examples, an initial screen may be displayed to the operator indicating that the station 112 may be awaiting initiation of an alert or an event by the operator through a detector.

The operator may initiate an alert upon, for example, determining the existence of an issue in the production workflow. In various examples, the operator may initiate the alert in a variety of manners. For example, the operator may scan his identification badge at the detector 114 at the station 112, as illustrated in FIG. 1. As noted above, the detector 114 may be an RFID reader, and the identification badge may have an RFID tag that can be read by the detector 114. In other examples, the identification badge may have a bar code or other printed identifier, and the detector 114 may be a barcode scanner or other optical scanner or detector.

The alert may be received by the station 112 through the detector 114 and, in some examples, may be signaled to the central processor. Upon receipt of the alert, the station 112 or the central processor 110 may present a user interface, such as a graphical user interface (GUI), to the operator. In various examples, the user interface may allow the operator to input information related to the issue which caused the operator to initiate the alert. As illustrated in the second screenshot in each of FIGS. 3A-3C, in some examples, the user interface may allow the operator to input an issue category. In the illustrated examples, the issue categories provided as options to the operator include resource issue, device issue and operator issue. In other examples, various other issue categories may be presented to the operator.

The selection of an issue category by the operator may be received by the station 112 or the central processor 110. Upon receipt of the selection of an issue category from the operator, the operator may be presented with options for specific issues related to the selected issue category. In the illustrated examples of FIGS. 3A-3C, various examples of specific issues are illustrated for each of the three issue categories presented in the second screenshot of FIGS. 3A-3C.

For example, referring to FIG. 3A, based on the selection of resource issue as the issue category, the user interface may allow the operator to input one or more selections from various resource issues. In the illustrated example of FIG. 3A, the resource issues presented to the operator may include “no paper” or “no ink”. Similarly, in the example of FIG. 3B, specific issues in the “device issue” category presented to the operator may include “broken part” or “unscheduled maintenance”, and in the example of FIG. 3C, specific issues in the “operator issue” category presented to the operator may include “medical reason” or “called at another station”. Of course, the specific issues in each category may be selected or customized, for example, for particular stations and particular production workflows.

Once the issue which caused the operator to initiate the alert is resolved, the screen may return to its “waiting” status, as illustrated in the fourth screenshot in each of the examples of FIGS. 3A-3C. Of course, additional levels of information may be included in obtaining information related to the issue. For example, in the example of FIG. 3B, upon receiving the selection of “broken part” from the operator, the operator may be presented with a list of parts associated with the station 112 to identify the broken part.

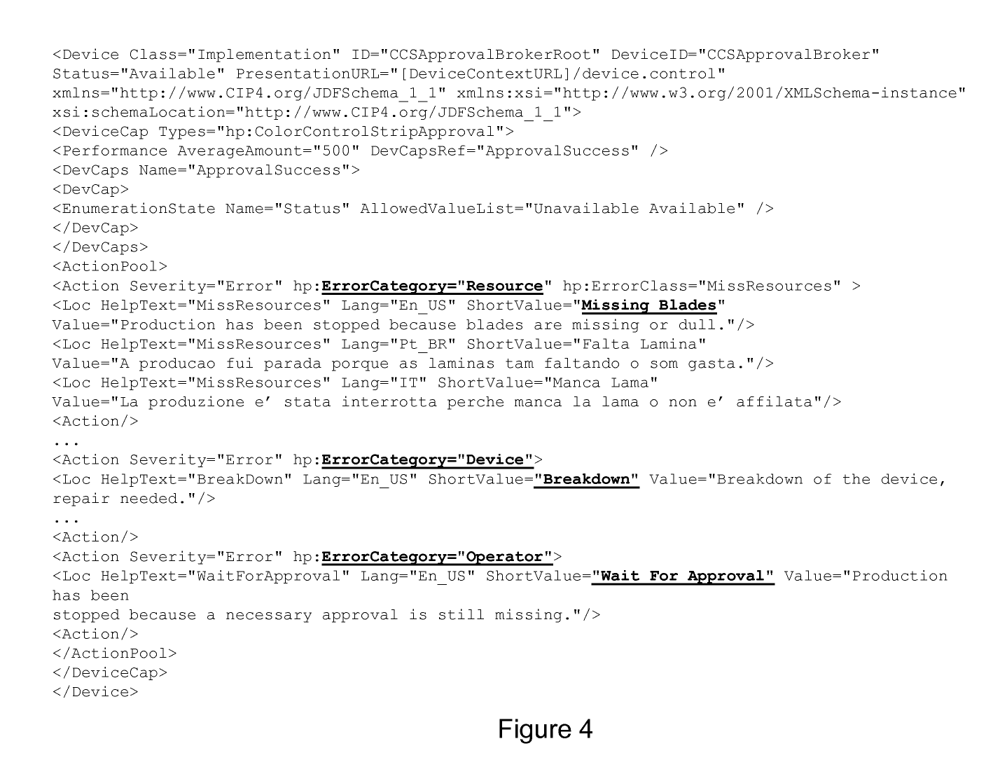

In various examples, the capture of information related to issues may be facilitated by use of the job definition format (JDF). JDF may be used for tracking of jobs in a production workflow. Thus, the use of JDF to capture issue-related information may be advantageous as being complementary to normal production workflow. Thus, the issue information may be captured as a regular part of the production workflow and may be integrated with JDF-augmented or JDF-enabled devices. Thus, specific configuration of the JDF-augmented devices may be incorporated into the issue-capture process. FIG. 4 illustrates example JDF code which may be used to capture issue information in various examples.

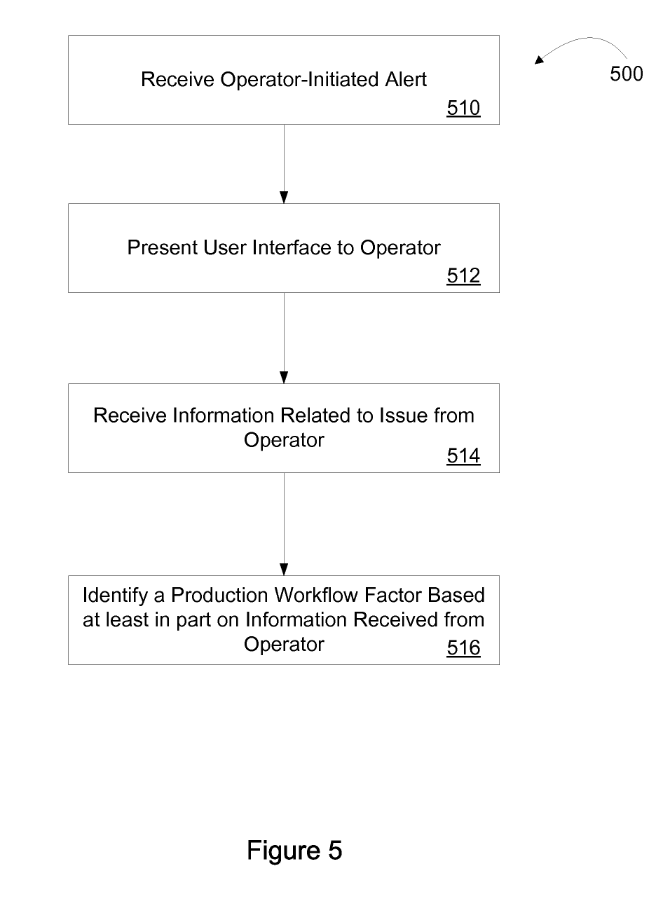

Referring now to FIG. 5, a flowchart illustrates an example process. In various examples, the example process 500 of FIG. 5 may be implemented in the central controller 110 illustrated in FIG. 1. In other examples, portions of the process 500 may be implemented in a combination of the central controller 110 and the various stations 112, 122, 132, 142 illustrated in FIG. 1.

In accordance with the example of FIG. 5, an operator-initiated alert may be received through a detector associated with the station 112 by, for example, the station 112 or the central controller 110 (block 510). As noted above, the operator-initiated alert may be received when the operator, for example, scans his badge at a detector of the station. In response to the operator-initiated alert, the station 112 or the central controller 110 may present a user interface to the operator (block 512). As described above with reference to FIGS. 3A and 3C, the user interface may be presented on a monitor or workstation associated with the station 112.

Through the user interface, the station 112 and/or the central controller 110 may receive information related to the issue (block 514). As described above with reference to FIGS. 3A-3C, the information may include an indication of an issue category and/or indication of a specific issue.

In various examples, the central controller may accumulate issues from one or more stations over a period of time. The accumulated issues may be used by the central controller to identify factors in the production workflow that, for example, may require addressing (block 516). For example, the central controller may identify a process bottleneck in the production workflow based on the accumulated issues. In other examples, the central controller may identify a defective piece of equipment that requires frequent replacement or maintenance, inadequate performance by an operator (e.g., due to frequent medical issues) or insufficient manpower (e.g., as may be indicated by an operator being called away from his station frequently). Of course, numerous other factors in the production workflow may be identified by the central processor that may require attention or addressing.

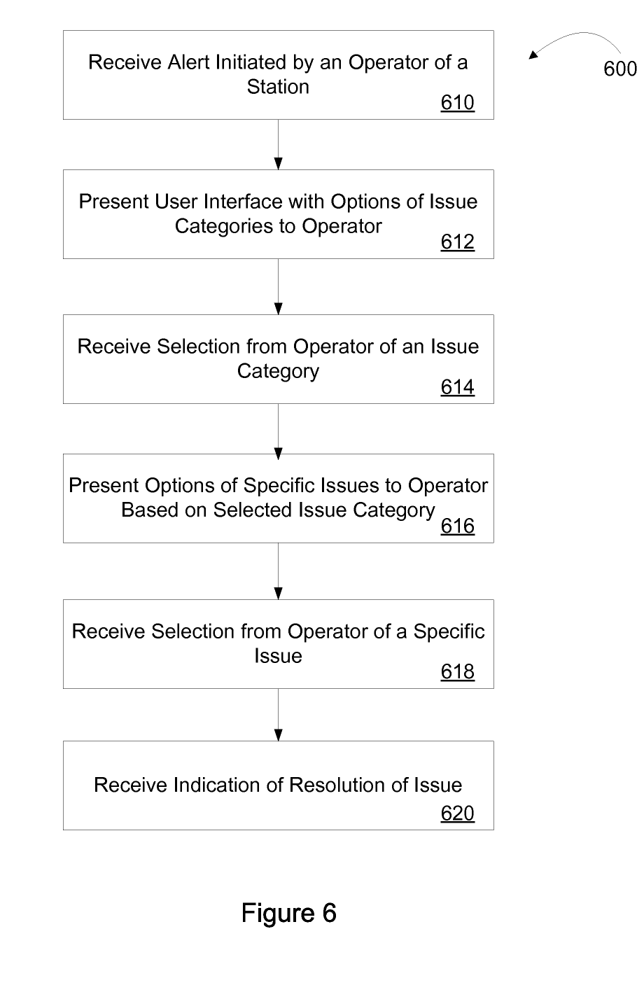

Referring now to FIG. 6, a flowchart illustrates another example process. In various examples, the example process 600 of FIG. 6 may be implemented in the central controller 110 illustrated in FIG. 1. In other examples, portions of the process 600 may be implemented in a combination of the central controller 110 and the various stations 112, 122, 132, 142 illustrated in FIG. 1.

In accordance with the example of FIG. 6, an operator-initiated alert may be received through a detector associated with the station 112 by, for example, the station 112 or the central controller 110 (block 610). In response to the operator-initiated alert, the station 112 or the central controller 110 may present a user interface with options of issue categories to the operator (block 612). For example, as illustrated in the examples of FIGS. 3A-3C, the issue categories presented to the operator may include resource issues, device issues and operator issues. The station 112 or the central controller 110 may receive a selection from the operator of an issue category (block 614).

Based on the selection of an issue category by the operator, the station 112 or the central controller 110 may present to the operator, through the user interface, options of specific issues (block 616). For example, as illustrated in the examples of FIGS. 3A-3C, various issues may be presented for each issue category that may be selected by the operator (e.g., the third screenshot in each of FIGS. 3A-3C). The station 112 or the central controller 110 may receive a selection from the operator of a specific issue (block 618).

The station 112 or the central controller 110 may further receive an indication of resolution of the issue (block 620). The indication of the resolution of the issue may be received by the station 112 or the central controller 110 either through an input from the operator or through detection of the resolution via sensors provided in the station 112. For example, sensors may provide an indication that paper has been added to resolve an issue of no paper.

As noted above, in various examples, the central controller may accumulate issues from one or more stations over a period of time and may use the accumulated issues to identify factors in the production workflow that, for example, may require addressing.

Thus, the central controller may monitor production workflow in a manner that is complementary to production workflow. The capture of information related to issues may be performed using the same technology as may be used in production workflow for job tracking, for example.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present invention and its practical application to enable one skilled in the art to utilize the present invention in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. A method, comprising:
receiving an alert initiated by an operator through a detector associated with a station in a production workflow;
presenting, responsive to the alert, a user interface to the operator;
receiving from the operator, via the user interface, information related to an issue; and
identifying a production workflow factor based at least in part on the information related to the issue received from the operator.

2. The method of claim 1, wherein the issue is at least one of an operator issue, a resource issue or a device issue.

3. The method of claim 1, wherein the production workflow factor is at least one of a process bottleneck, a defective equipment, performance of an operator, or insufficient manpower.

4. The method of claim 1, wherein the detector is at least one of a radio frequency identifier (RFID) reader or an optical scanner.

5. The method of claim 1, wherein the receiving from the operation information related to an issue comprises:
receiving from the operator, via the user interface, a category of the issue;
presenting to the operator, via the interface, a list of issue identifiers corresponding to the category; and
receiving from the operator, via the user interface, a selection of an identification of an issue from the list of issue identifiers.

6. A computer program product, embodied on a non-transitory computer-readable medium, comprising:
computer code for presenting a user interface to an operator associated with a station in a production workflow in response to an alert initiated by the operator through a detector associated with the station;
computer code for receiving from the operator, via the user interface, an indication of a category of an issue;
computer code for presenting to the operator, via the user interface, a list of issue identifiers corresponding to the category;
computer code for receiving from the operator, via the user interface, a selection of an identification of an issue from the list of issue identifiers; and
computer code for identifying a production workflow factor based at least in part on the information related to the issue received from the operator.

7. The computer program product of claim 6, wherein the issue is at least one of an operator issue, a resource issue or a device issue.

8. The computer program product of claim 6, wherein the production workflow factor is at least one of a process bottleneck, a defective equipment, performance of an operator, or insufficient manpower.

9. The computer program product of claim 6, wherein the detector is at least one of a radio frequency identifier (RFID) reader or an optical scanner.

10. The computer program product of claim 6, further comprising:
computer code for receiving the alert initiated by the operator through the detector associated with a station in the production workflow.

11. A system, comprising:
a central controller;
at least one station associated with a production workflow, the at least one station having a detector and a user interface for receiving input from an operator associated with the at least one station, the at least one station being in communication with the central controller;
wherein the central controller:
presents the user interface to the operator in response to an alert initiated by the operator through the detector;
receives from the operator, via the user interface, information related to an issue; and
identifies a production workflow factor based at least in part on the information related to the issue received from the operator.

12. The system of claim 11, wherein the issue is at least one of an operator issue, a resource issue or a device issue.

13. The system of claim 11, wherein the production workflow factor is at least one of a process bottleneck, a defective equipment, performance of an operator, or insufficient manpower.

14. The system of claim 11, wherein the production workflow includes a print service.

15. The system of claim 11, wherein the at least one station comprises:
a detector for receiving the alert from the operator, wherein the detector is at least one of a card reader, a badge reader or a radio frequency identifier (RFID) reader.
